(19) United States
(12) Patent Application Publication
(10) Pub. No.: US 2008/0087837 A1
(43) Pub. Date: Apr. 17, 2008

(54) Non-invasive method for measuring soil water content or snow water equivalent depth using cosmic-ray neutrons

(76) Inventors: Darin Desilets, Tucson, AZ (US); Marek Zreda, Tucson, AZ (US)

Correspondence Address: Darin Desilets, 5212 North Pueblo Villas Drive, Tucson, AZ, 85704, US

(21) Appl. No.: 11/545,851

(22) Filed: Oct. 11, 2006

(51) Int. Cl. G01N 23/00

(52) U.S. Cl. 250/390.05

(57) ABSTRACT

The present invention is directed toward the determination of soil water content and the water equivalent depth of snow deposited on top of the ground. The apparatus for measuring soil water content consists of one or more cosmic-ray neutron detectors located above the soil surface. The detectors record neutrons in the thermal, epithermal or fast energy bands. Snow water equivalence is determined by using a thermal neutron detector and an epithermal or fast neutron detector. Neutron count rates for all three energy bands decrease monotonically with increasing soil water content. Epithermal and fast neutron count rates decrease monotonically with increased snow water equivalent depth, but thermal neutron count rates increase at first and then decrease with increasing snow cover.

### BACKGROUND OF THE INVENTION

The invention is intended to measure water content in the top 50 cm of soil or solid earth, and to measure the water equivalent depth of snow or ice at the land surface. The invention utilizes measurements of naturally-occurring neutrons generated in cosmic ray interactions with air and solid materials to accomplish this task. The primary advantages of this method over existing methods is that soil water content and snow pack thickness can be measured without artificial radioactive sources, non-invasively, non-destructively, automatically, remotely and at a spatial scale and sample volume not attainable with other instruments.

Most methods for measuring soil water content disturb the soil and operate at small scales that can be considered nearly point measurements. As summarized in Gardner (1986), soil water content can be measured directly by oven drying and indirectly using tensiometric, electromagnetic and nuclear methods. The small scale and invasive nature of current methods make them unsuitable for many applications.

Current methods for measuring moisture that take advantage of the strong neutron moderating ability of water, such as nuclear moisture meters, employ man-made radioactive neutron sources that are essentially point sources intended to be used in boreholes. The invention described herein differs from the currently practiced nuclear methods in that it utilizes naturally occurring neutron fluxes generated by energetic cosmic rays, and in that the source is distributed both laterally and vertically in the soil and air rather than as a point source.

Accurate snow water equivalent measurements are difficult to obtain remotely, and therefore require laborious, expensive and time consuming gravimetric measurements of snow pack that are manually acquired by sampling teams. An alternative is the snow pillow, which measures the weight of snow over a small area and converts the weight to the snow water equivalent by dividing by the surface area of the pillow. That method is expensive and has at least one major flaw: only a small area is covered by the pillow, so heterogeneities in the snow pack, for example, due to drifting snow, can produce misleading results. Aerial surveys of gamma radiation before and during the winter season have also been used to infer snow water equivalent depth. That method has proved suitable for gross estimates of snow pack at large scales, but aerial gamma surveys are sensitive to a much larger radius than the 10-100 m radius of the invention disclosed herein, and furthermore aerial gamma surveys are beset by problems in distinguishing the effects of soil water content from snow. The invention described herein differs from currently practiced aerial surveys in that it utilizes cosmic-ray neutron radiation rather than natural gamma radiation that originates within the rocks.

Various ways of utilizing cosmic rays for the measurement of snow pack or soil water content have previously been disclosed by others. These methods all differ substantially from the invention disclosed here. Kastner and others (U.S. Pat. No. 3,602,713) disclosed a method where water content was determined from cosmic-ray neutron fluxes measured with detectors implanted in the soil. That method, unlike the one disclosed here, is invasive and only responds to a small volume of soil located around the detector. D. Wada and others (U.S. Pat. No. 4,047,042) disclosed a method that is based on the simple exponential attenuation of a beam of cosmic rays passing through snow. They utilized a detector buried at a shallow depth in the ground, which makes their method invasive and also severely limits the measured sample volume. Contrastingly, the method disclosed here utilizes a detector or detectors placed above the snow or soil, and therefore is non-invasive and responds to a much larger surface footprint. Also, rather than relying on the simple attenuation characteristics of cosmic-rays as do Wada and others, the present method utilizes the ability of hydrogen in water to slow down energetic neutrons and to capture slow and thermal neutrons. Abelentsev and others (U.S. Pat. No. 4,992,667) described a method for measuring soil or snow water content by measuring cosmic rays. That method is similar to the one proposed by Wada and others but involves using several radiation detectors. Abelentsev proposed using two neutron detectors, one located above the soil and one located within the soil, together with a gamma detector located above the soil to measure soil or snow water content. Contrastingly, the present method can be implemented with only one detector, and does not require a gamma detector above the ground nor a buried neutron detector. Condreva (U.S. Pat. No. 6,663,012) described a method which utilizes the attenuation of cosmic-ray gamma and muon fluxes to measure water content at depths of greater than 100 cm, in contrast to the present method which uses only neutron fluxes and is concerned primarily with depths less than 50 cm.

None of the techniques described previously disclose or suggest that it is possible to non-invasively measure soil water content or snow pack over a broad area (tens to hundreds of square meters) by utilizing the tendency of water to moderate and capture neutrons produced by interactions with cosmic rays. All previously described methods involve inserting at least one detector into the ground, which is a major practical drawback because it limits the spatial scale of the measurements, makes installation more difficult, and disturbs the soil structure, thereby altering soil properties. The non-invasive nature of the invention disclosed here makes it a substantial improvement over all previously described methods for utilizing cosmic rays to measure soil water content and snow pack thickness.

### SUMMARY OF THE INVENTION

Cosmic-ray protons and heavier nuclei constantly bombard Earth. The more energetic cosmic-ray particles collide with nuclei at the top of the atmosphere and initiate cascades composed of secondary hadrons (primarily neutrons and protons) that propagate through the atmosphere in a chain reaction. Hadron cascades attenuate exponentially as a function of the mass of atmosphere traversed due to elastic and inelastic collisions with atmospheric nuclei. A small but easily measurable portion of the energetic hadron flux reaches sea level, where secondary particles interact with soil nuclei (primarily silicon and oxygen). Neutrons with energies on the order 1-10 MeV are evaporated from soil nuclei following such interactions. Neutrons are also evaporated from atmospheric nuclei through collisions with energetic secondary particles. These evaporation neutrons are known as “fast neutrons”.

An evaporation neutron is reduced in energy through elastic scattering by air and soil nuclei. These collisions eventually bring the neutron to near thermal equilibrium with the surrounding air or soil nuclei. At these low energies, on the order of 0.025-1 eV, neutrons are eventually absorbed by various nuclei in the soil. Neutrons at energies just above thermal energy are known as epithermal neutrons.

The main premise of the method described herein is that fluxes of cosmic-ray generated neutrons above the soil surface in the fast to thermal energy region are controlled primarily by water content, or more precisely by hydrogen content. Water exerts an influence on neutron fluxes in two ways: by increasing the rate at which fast neutrons are slowed to thermal energies and by increasing the rate of absorption of thermal neutrons. Increased water content or snow cover means a monotonic decrease in the fast to epithermal neutron flux. Thermal neutrons may behave non-monotonically to snow or soil moisture, with neutron fluxes increasing with increasing with soil water content at low soil water contents and decreasing with soil water content at higher water contents. If snow is not present, soil water content can be determined using a single detector and an appropriate calibration curve. If soil water content is known, then snow pack thickness can be determined using one detector and an appropriate calibration curve. By using two or more detectors having different energy sensitivities, with at least one sensitive to thermal neutrons and one sensitive to epithermal or fast neutrons, the changes in snow pack and water content can be distinguished.

### BRIEF DESCRIPTION OF THE DRAWINGS

The accompanying drawings, which are incorporated in and form part of the specification, illustrate the present invention and, together with the description, form part of the invention. The appended drawings illustrate only typical embodiments of the invention and are not to be considered limiting in its scope for the invention may admit to other equally effective embodiments.

FIG. 1 shows the dependence of relative count rates for different neutron energy bands on soil water content. The modeled medium is a homogenous silica sand soil with a bulk density of 1.4 g cm⁻². The lines labeled thermal, epithermal and fast are from neutron transport simulations, while the line labeled “Equation 4” is from the analytical treatment outlined in the Theory section of the description.

FIG. 2 shows the dependence of relative count rates for different neutron energy bands on snow water equivalent depth. The modeled medium is a homogenous silica sand soil with a bulk density of 1.4 g cm⁻³ and a volumetric water content of 10%. The lines labeled thermal, epithermal and fast are from neutron transport simulations.

FIG. 3 shows a schematic representation of the major elements of the neutron detection and logging system and shows three types of detector configurations. The thermal neutron counting configuration consists of an unshielded proportional counter tube; the epithermal neutron counting configuration uses a proportional counter tube of the same type covered in cadmium shielding; the fast neutron counter has both a polyethylene and cadmium cover.

FIG. 4 shows (A) epithermal neutron count rates, (B) thermal neutron count rates and (C) soil water content as a function of time from the same field site. The vertical bars labeled I, II and III correspond to three major precipitation events that affected the field site.

### DETAILED DESCRIPTION OF THE INVENTION

### Theory of Measurement

Cosmic ray neutrons and protons collide with soil and air nuclei, unleashing evaporation neutrons with energies on the order of 1-10 MeV. The rate at which evaporation neutrons are generated by cosmic-rays depends on the intensity of the generating component, which decreases exponentially with mass shielding depth in the atmosphere and ground. Neutron intensities are therefore highest in the upper layers of the soil and at high altitude locations. As explained below, the relative neutron intensities at a given location are primarily a function of water content.

### Measuring Soil Water Content

Neutron fluxes in the subsurface are controlled by the scattering and absorption properties of soil elements. The two most important scattering properties are the macroscopic elastic scattering cross section, Σₛ, and the average logarithmic energy decrement per collision, ξ. The elastic scattering cross section of an element is proportional to the probability that a neutron will collide with the nucleus in such a way that momentum is conserved. The energy lost by the neutron through elastic collisions is described by the average logarithmic energy decrement. The tendency for soil nuclei to absorb neutrons is expressed by the macroscopic absorption cross section, Σₐ. Macroscopic cross sections are calculated by multiplying microscopic cross sections for individual soil elements by their atomic abundances.

Absorption cross sections depend more strongly on energy than do scattering cross sections. At energies above a few eV, absorption generally becomes negligible and the neutron flux at a given energy is controlled entirely by the rate at which neutrons are scattered down to lower energies. In this case, the subsurface equilibrium neutron flux at energy E is given by Glasstone and Edlund (1952):

$${φ}_{gnd} ( E ) = \frac{{Q}_{gnd}}{E {ξ}_{gnd} {\sum }_{s , gnd}} \qquad ( 1 )$$

where Q_{gnd} is the neutron source intensity in the ground and Σ_{s,gnd} and ξ_{s,gnd} are calculated from the elemental composition of the soil according to Glasstone and Edlund (1952). The neutron source intensity is proportional to the intensity of energetic cosmic rays.

The product ξ·Σ is known as the slowing down power of an element or material. A greater slowing down power means neutrons are more effectively moderated, which makes the flux at E lower. Because values of both ξ and Σ are much larger for hydrogen than for any other major element, the slowing down power of a soil is dominated by the hydrogen contained in water. For example, in a silica sand with a water content of only 5% v/v (ρ_{b}=1.4 g cm⁻²), the hydrogen in soil water accounts for nearly 80% of the slowing down power of the soil.

The neutron flux at the land surface also includes neutrons produced and moderated in air. Because neutron scattering properties of the air do not change much over time (water vapor does vary with time but constitutes less than 0.1% of the atmosphere), atmospheric neutron fluxes are mostly a constant background that is superimposed on a variable soil neutron signal. The flux of neutrons in the air is given by:

$${φ}_{air} ( E ) = \frac{{Q}_{air}}{E {ξ}_{air} {\sum }_{s , air}} \qquad ( 2 )$$

and the total flux measured at the land surface can be approximated by

φₜₒₜₐₗ=φₐᵢᵣ+φ_{gnd} (3)

If the source intensity is the same for the air and ground, the ratio of the neutron fluxes between a wet soil and dry soil is given by:

$$\frac{{φ}_{wet gnd}}{{φ}_{dry gnd}} ( E ) = \frac{{( {ξ}_{air} {\sum }_{s , air} )}^{- 1} + {( {ξ}_{wet gnd} {\sum }_{s , wet gnd} )}^{- 1}}{{( {ξ}_{air} {\sum }_{s , air} )}^{- 1} + {( {ξ}_{dry gnd} {\sum }_{s , dry gnd} )}^{- 1}} \qquad ( 4 )$$

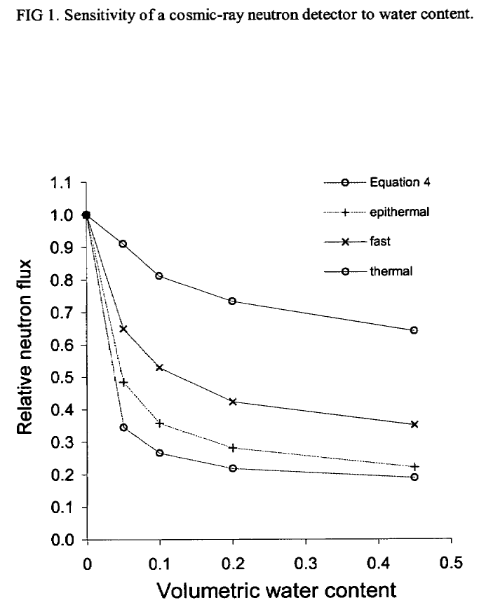

The predicted ratio φ_{wet gnd}/φ_{dry gnd} for different volumetric water contents soil of silica sand are given in FIG. 1.

Equation 4 only approximates the true physical system. In reality, neutrons near the air-ground interface can be generated in one medium but moderated in the other. Because different elements emit different numbers of neutrons on average, and because the source is more attenuated in the ground than in the air, the neutron production rates in the two media are not equal as equation 4 assumes. Equation 4 also assumes that the elastic scattering cross sections are independent of energy and that neutron absorption is negligible.

The most physically realistic approach to modeling neutron fluxes is to run sophisticated Monte Carlo neutron transport models. The model used for this work assumes that the neutron source intensity decreases exponentially with depth in the atmosphere and soil with an attenuation length of 140 g cm⁻², and that neutrons are emitted from atmospheric and soil nuclei according to an evaporation energy spectrum peaked at 1 MeV. The relative source intensities for air and ground were determined from a separate simulation using a high-energy neutron transport code to propagate energetic cosmic-ray cascades from the top of the atmosphere to sea level.

There are three important implications to equation 4. First, it demonstrates the dominant role of soil water content in modulating neutron fluxes at the land surface. Second, it predicts that soil neutron fluxes decrease monotonically with increasing soil water content at energies above the thermal region. Third, it suggests that at energies far enough above the absorption region, and far enough below the source energy, the sensitivity to water content will be independent of energy.

Measuring Snow Pack Thickness (or its Water Equivalent)

When soil water content is known independently, then snow pack water equivalent depth can be determined with this invention using only one neutron detector. Increasing the snow cover is effectively the same as increasing the slowing down power of the soil, and therefore neutron fluxes above thermal energies will decrease monotonically with increasing snow water equivalent depth.

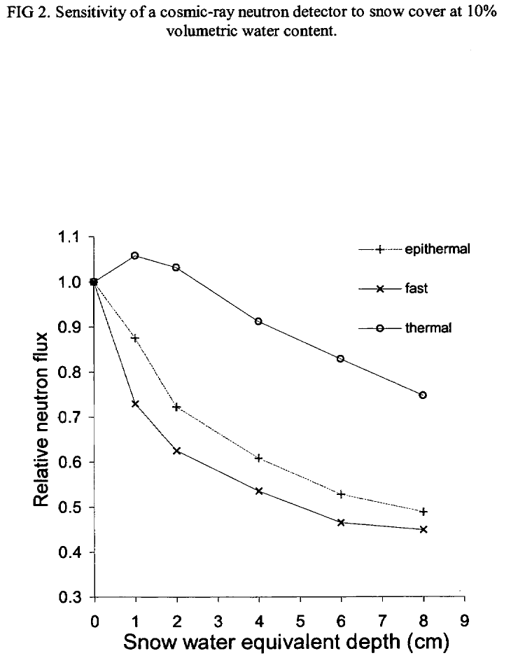

When the effects of soil water need to be distinguished from snow cover, then at least two detectors should be employed. One detector should be sensitive to neutrons at energies close to the thermal region and the other detector should measure fast or epithermal neutrons. FIG. 2 shows that snow accumulation first leads to an increase in the near surface thermal neutron flux, while simultaneously leading to a decrease in the fast and epithermal neutron fluxes. This behavior is a clear indication of snow cover, and can be quantitatively related to the snow water equivalent depth by examining the ratio of thermal neutron counts to fast or epithermal neutron counts.

### Equipment and Measurement Technique

The invention can use one or a combination of several techniques for detecting neutrons. The preferred embodiment of the invention uses gas filled proportional counters (for example, filled with ³He or ¹⁰BF₃ gas) to detect neutrons but can also use gas recoil proportional counters, scintillation counters or any other neutron detection method that is sensitive in the thermal to fast energy range. Methods for detecting neutrons in the thermal to fast energy range are well-established and are described in detail by Knoll (2000).

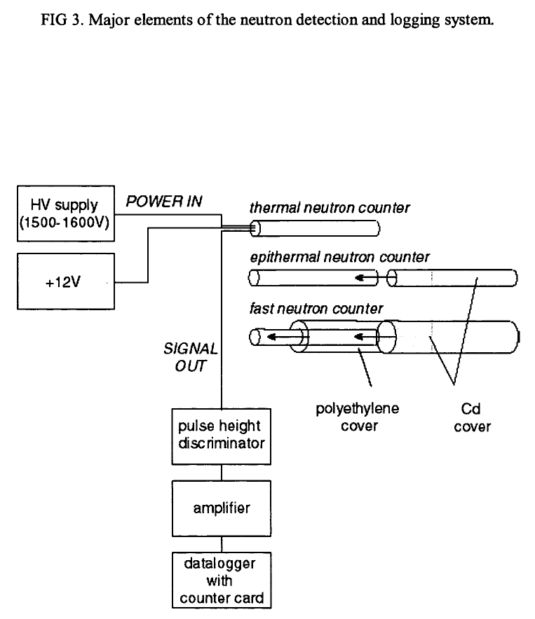

The major elements of the neutron detection system in the preferred embodiment of this invention are described in FIG. 3. A minimum of one detector placed on or above the ground can be used to measure soil water content or snow water equivalent depth. By changing the energy sensitivity of the detector one can change the spatial sensitivity of the apparatus to soil water content or snow water equivalent depth. According to FIG. 1, the sensitivity to moisture content is highest for neutrons with energies above the thermal region but below the initial energy of the evaporation neutrons. However, other energies in the fast to thermal range may be preferable to measure, particularly if those energies yield a better signal-to-noise ratio or better counting statistics.

The spatial scale of measurements can also be changed by changing the energy sensitivity of the detector. Neutrons at lower energies experience more collisions and therefore travel a longer path length before reaching the detector than neutrons at higher energies. A detector sensitive to neutrons at lower energies will therefore respond to a larger surface area and a greater sample depth than one sensitive to higher energies.

For detecting thermal neutrons, the preferred apparatus consists of one or more ¹⁰BF₃ or ³He filled proportional counters, for example of the type manufactured by GE Reuter-Stokes of Twinsburg, Ohio. The preferred dimensions are 2.5-5.0 cm in diameter and 30-120 cm in length, and the preferred fill pressure is 4-10 atm. The detectors at the larger end of this range provide higher count rates and therefore may be preferable when high resolution data are needed or for measurements at low elevation where cosmic ray fluxes are smaller.

For detecting epithermal neutrons, the preferred apparatus consists of one or more of the said proportional counters covered by a 0.5-0.7 mm thick cylindrical shell of cadmium. Cadmium serves the purpose of preventing thermal neutrons from reaching the detector.

For detecting fast neutrons, the preferred apparatus consists of one or more of the said proportional counters, covered by a 1 to 10 cm cylinder of polyethylene or other hydrogenous material, which is in turn covered by a 0.5-0.7 mm thick cadmium cylinder. The polyethylene serves the purpose of moderating fast neutrons so that they can be detected by the proportional counter tube.

The associated pulse processing electronics and high voltage supply for the proportional counter tubes in the preferred embodiment are of the type provided by Precision Data Technologies Inc., of Everett, Wash. The output from the electronics units are TTL pulses, which can be recorded using commercially available counter/timer cards or any data logger that includes said counter cards. Counts from the detectors or arrays of detectors of the sane type are logged at the desired time interval and stored in computer memory. Counts can be corrected for atmospheric pressure and solar activity using computer software.

Detectors can be placed in a small building or shed, or on the top or side of a tower or other structure. Detectors can also be placed on the ground. Increasing the elevation of the instrument above the ground increases the measurement footprint. Placing the detector near or in a large building may change the sensitivity of the instrument so that a site-specific calibration is needed. Site specific calibration can be obtained by taking multiple gravimetric soil samples in a 20-100 m radius around the building during wet and dry conditions.

### Corrections to Data

Besides soil water content and snow water equivalent depth, there are primarily two time-dependent influences on the cosmic-ray neutron flux. These two other influences on the neutron flux should be corrected for. One influence is atmospheric pressure, which varies in time due to changes in weather. Lower-than-normal atmospheric pressure means that secondary neutron cascades pass through less atmosphere than they otherwise would, and are therefore less attenuated, resulting in higher neutron fluxes. Higher-than-normal atmospheric pressure has the opposite effect. The count rate at atmospheric pressure P [mb] can be corrected to a standard pressure P₀ by multiplying the count rate by the correction factor f_{P}, given as

f_{P}=exp[(P−P₀)/Λ] (5)

where Λ is the atmospheric attenuation length, which has a value of approximately 132 mb at low altitude, mid- to high-latitude locations. Atmospheric pressure can be determined using local pressure measurements from a pressure transducer or pressure measurements from nearby weather stations or radiosondes. Variations in the count rate due to changing atmospheric pressure are typically smaller than 10% over the course of a month.

Another correction is for solar activity, which modulates the primary cosmic-ray flux as it passes through the heliosphere and before it reaches earth. The correction for solar activity is generally small near sea level and at low latitudes. The correction is small in these places because only cascades initiated by the most energetic primary particles reach sea level or low-latitudes, and these very energetic primaries are not strongly influenced by solar magnetic fields. Where the correction is significant, data from the world wide network of neutron monitors can be used to correct count rates. Preferably, data from neutron monitor stations that are close in latitude and altitude to the study area should be used for corrections.

### EXAMPLE

### Calibration and Test Results

The present invention was tested in the winter of 2003 at a field site located outside of Tucson, Ariz. Two detectors were located inside of a building at a height of 1 m above the ground. One detector recorded thermal neutrons and the other detector recorded epithermal neutrons. A water content reflectometer, a standard instrument for point measurement of soil water content, was buried at a depth of 10 cm in the soil to measure changes in volumetric water content. The designs of these detectors and of the detection system were as described above and in FIG. 3. Barometric pressure was recorded at the site and the correction given by equation 5 was applied.

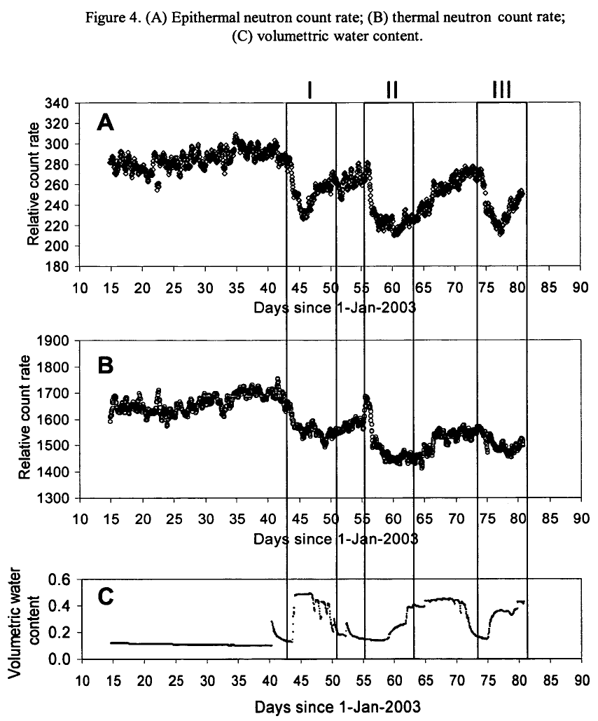

The results of this experiment are shown in FIG. 4. These results show three major dips in neutron count rates, which correspond to three major storms that affected the field site. The first storm, labeled I on FIG. 4, was characterized by low intensity rain, and resulted in corresponding dips in both thermal and epithermal count rates, which is consistent with the response predicted in FIG. 1. This was followed by drying of the upper layers and increasing neutron fluxes recorded above the ground. The second storm, labeled II on FIG. 4, was a snow storm that was followed by rapid melting of snow. In accordance with FIG. 2, the thermal detector first records a rise in the count rate in response to snow, which is followed by a dip in the count rate that corresponds to melting of the snow and saturation of the soil. The epithermal detector, conversely, shows a monotonic decrease in response to increased snow or water. The third storm, labeled III on FIG. 4, was another snow storm that was characterized by rapid snow melt. The rise in the thermal neutron count rate was not observed in this case because, probably because snow fall was less abundant.

These results demonstrate cosmic ray neutron fluxes measured above the soil surface respond strongly to soil water content and snow cover, and that snowfall can be distinguished from soil water content by comparing thermal neutron count rates to epithermal or fast neutron count rates.

The main advantages of this method are that a larger area is covered per instrument than any currently available ground or near-surface based instrument, and that the method can be operated remotely, automatically, non-invasively and non-destructively.

While the methods and forms of the apparatus herein described constitute the preferred embodiments of this invention, it is to be understood that the invention is not limited to these precise methods and forms of apparatus, and that changes may be made therein without departing from the scope of the invention.

We claim:

1. A non-invasive method for making relative and absolute measurements of water content in the upper 0.5 m of soil and solid earth, and for measurements of the water-equivalent depth of a snow pack, comprising:
(a) one or more cosmic-ray neutron detectors located above the land or snow surface;
(b) measurements in two or more different cosmic-ray neutron energy bands to distinguish water contained in snow from soil water;
(c) the placement of detectors at different heights above the soil or snow in order to change the footprint (measurement area) and sample volume of the measurements;
(d) means for converting response of said detectors into measures of water content or water-equivalent depth of a snow pack.
